(19) United States
(12) Patent Application Publication
(10) Pub. No.: US 2010/0300196 A1
(43) Pub. Date: Dec. 2, 2010

(54) IMAGE FORMING APPARATUS AND VIBRATION ISOLATOR SELECTION METHOD

(75) Inventor: Tokihiko ISE, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/787,960

(22) Filed: May 26, 2010

Related U.S. Application Data
(60) Provisional application No. 61/182,212, filed on May 29, 2009.

(51) Int. Cl. G01L 5/04; G03G 15/00

(52) U.S. Cl. 73/159; 73/579; 399/16

(57) ABSTRACT

An image forming apparatus includes a media sensor which a sheet carrying device has at a halfway part in a sheet carrying path, a damper table which stores a frequency band of vibration to be absorbed for each type of vibration isolator, and a controller which samples an output from the media sensor, performs Fourier transform on a waveform acquired as a result of the sampling, thus calculates a frequency, then searches the damper table on the basis of the resulting frequency, reads an optimum vibration isolator, and outputs the optimum vibration isolator to a control panel.

### CROSS-REFERENCE TO RELATED APPLICATIONS

This application is based upon and claims the benefit of priority from the prior U.S.A. Patent Application No. 61/182,212, filed on May 29th, 2009, and the entire contents of which are incorporated herein by reference.

### FIELD

The present invention relates to an image forming apparatus and a vibration isolator selection method that facilitate selection of a vibration isolator for a media sensor which detects the thickness of a sheet.

### BACKGROUND

An image forming apparatus has a media sensor which detects the thickness of a carried sheet. The image forming apparatus changes an image forming method according to the thickness of a sheet detected by the media sensor or discharges a sheet having an unexpected thickness.

If vibration is applied to the media sensor, the media sensor may make an error in the detection of the thickness of a sheet in the image forming apparatus, there are vibrations with various frequencies including vibration generated when a sheet is carried and vibration generated by a driving device such as a motor.

The media sensor has a noise filter as a vibration damping measure. The noise filter can cancel noise that is caused by vibration with respect to a specific frequency. However, there is a problem that it is difficult to replace the noise filter if the frequency of vibration that exists in the image forming apparatus is different from the frequency that can be canceled by the noise filter.

To cope with this problem, a technique of providing a vibration isolator at a site where the sensor is attached is proposed.

### DESCRIPTION OF THE DRAWINGS

FIG. 1 shows the configuration of an image forming apparatus.

FIG. 2 is a perspective view showing the appearance of a media sensor unit.

FIG. 3 is a perspective view of a media sensor.

FIG. 4 is a lateral sectional view of the image forming apparatus, showing the vicinity of the media sensor.

FIG. 5 is a perspective view of the image forming apparatus, showing the vicinity of the media sponsor.

FIG. 6 is a perspective view showing an example of a vibration isolator.

FIG. 7 is a lateral sectional view showing the vicinity of the vibration isolator.

FIG. 8 is a schematic view showing the configuration of the image forming apparatus.

FIG. 9 shows a vibration detected by the image forming apparatus on the basis of an output from the media sensor.

FIG. 10 is a flowchart showing the operation of the image forming apparatus.

FIG. 11 is a perspective view showing the vicinity of a isolator changer.

FIG. 12 is a front view showing the vicinity of the isolator changer.

FIG. 13 is a front perspective view of a gear.

FIG. 14 is a back perspective view of the gear.

FIG. 15 is a flowchart showing vibration isolator automatic replacement in the image forming apparatus.

### DETAILED DESCRIPTION

Throughout this description, the embodiments and examples shown should be considered as exemplars, rather than limitations on the apparatus and methods of the present invention.

Hereinafter, an embodiment of an image forming apparatus and a vibration isolator selection method will be described in detail with reference to the drawings.

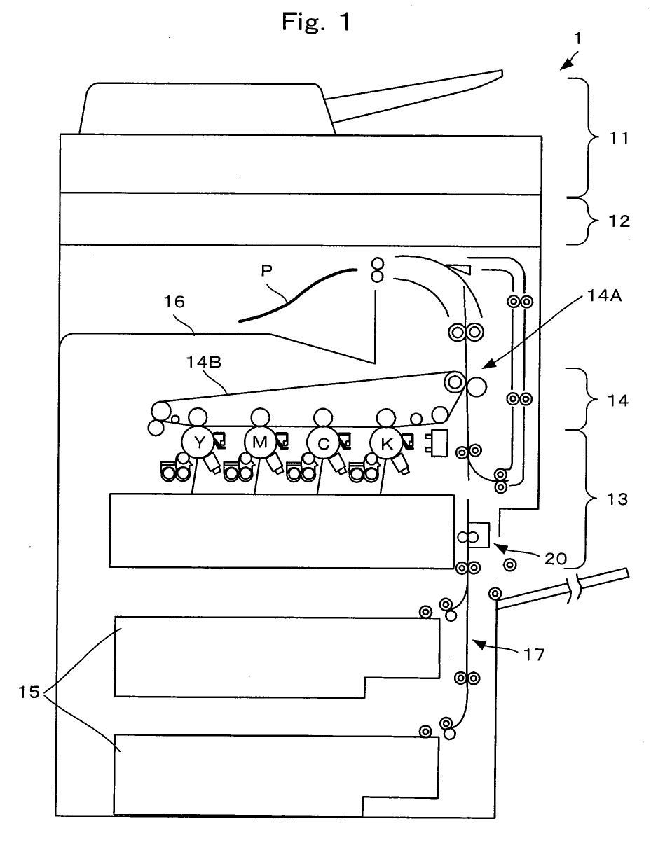

FIG. 1 shows the configuration of an image forming apparatus 1 according to this embodiment. As shown in FIG. 1, the image forming apparatus 1 has an automatic document feeder 11, a scanner 12, an image forming unit 13, a transfer unit 14, a sheet carrying device 17, and a sheet feeder 15.

The image forming apparatus 1 has the automatic document feeder 11 in such a manner that the automatic document feeder 11 can open and close on top of the body of the image forming apparatus 1. The automatic document feeder 11 has a document carrying mechanism which takes out sheets of a document one by one from a paper supply tray and carries the sheets to a paper discharge tray.

The automatic document feeder 11 with its document carrying mechanism carries sheets of a document one by one to a document scanning part of the scanner 12. It is also possible to open the automatic document feeder 11 and place a document on a document table of the scanner 12.

The scanner 12 has a carriage having an exposure lamp for exposing a document to light and a first reflection mirror, plural second reflection mirrors with, which a body frame of the image forming apparatus 1 is engaged, a lens block, and a CCD (charge coupled device) of an image scanning sensor.

The carriage stands still on in a document scanning part or reciprocates below the document table and thus causes the first reflection mirror to reflect light from the exposure lamp reflected by the document. The plural second reflection mirrors reflect the reflected light from the first reflection mirror to the lens block. The lens block varies the magnification of the reflected light and then outputs the resulting light to the CCD. The CCD converts the incident light to an electrical signal and outputs the electrical signal as an image signal to the image forming unit 13.

The image forming unit 13 has a laser irradiation unit, a photoconductive drum as an electrostatic latent image carrier, and a developer supply unit, for each of yellow Y, magenta M, cyan C, and black K.

The laser irradiation unit irradiates the photoconductive drum with a laser beam based on an image signal and thus forms an electrostatic latent image on the photoconductive drum. The developer supply unit supplies a developer to the photoconductive drum and forms a developer image based on the electrostatic latent image.

The sheet feeder 15 takes out sheets one by one from a paper supply cassette and delivers the sheet to the sheet carrying device 17. The sheet carrying device 17 carries the sheet to the transfer unit 14.

The transfer unit 14 has a transfer belt 14B, transfer roller as a transfer device, and a fixing device 14A. The transfer belt 14B, as an image carrier, has the developer image on the photoconductive drum transferred thereto and carries the developer image. The transfer roller applies a voltage or pressure and thus transfers the developer image on the transfer belt to the sheet that is carried thereto. The fixing device 14A heats and pressurizes the developer image and thus fixes the developer image to the sheet.

The image forming apparatus 1 has a media sensor unit 20 which detects the thickness of a sheet, at a halfway part in a sheet carrying path of the sheet carrying device 17. The image forming apparatus 1 has the media sensor unit 20 upstream from the fixing device 14A of the transfer unit 14 in the sheet carrying direction.

A sheet P discharged from a paper discharge port is stacked on a paper discharge tray 16.

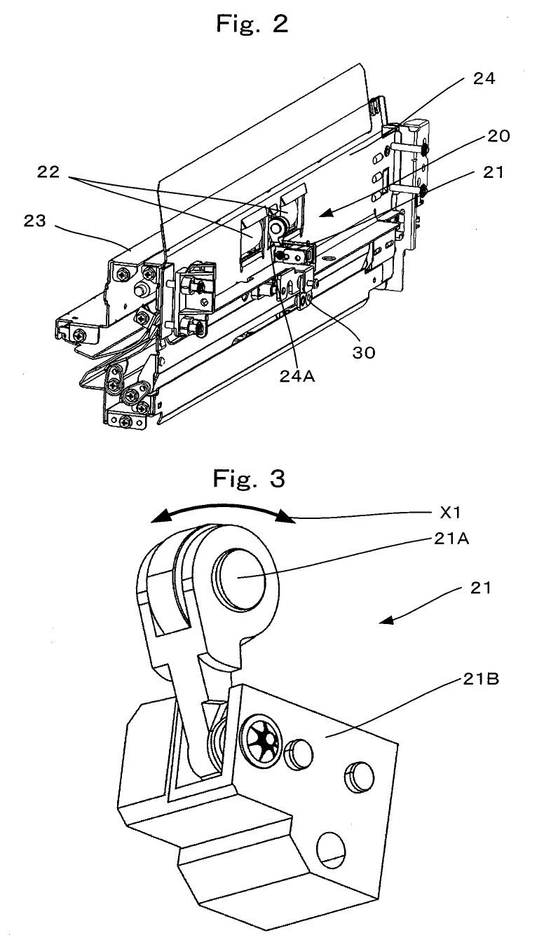

FIG. 2 is a perspective view showing the appearance of the media sensor unit 20. As shown in FIG. 2, the media sensor unit 20 has a media sensor 21, a pair of conveyance rollers 22, and a pair of conveyance rollers which follows and rotates with the sheet carrying driving rollers 22.

The image forming apparatus 1 has a first sheet guide 23 and a second sheet guide 24 in the sheet carrying device 17. In the image forming apparatus 1, a sheet is carried through the gap between the first sheet guide 23 and the second sheet guide 24. The image forming apparatus 1 has an aperture 24A in the second sheet guide 24 for a roller 21A of the media sensor 21 to contact the carried sheet.

The media sensor 21 is attached to the second sheet guide 24 via a vibration isolator 30.

FIG. 3 is a perspective view of the media sensor 21. As shown in FIG. 3, the media sensor 21 has the roller 21A and a sensor body 21B. The roller 21A has a roller at one end and its other end is attached to the sensor body 21B in a turnable manner in the direction of an arrow X1.

The media sensor 21 detects the thickness of a sheet, for example, with a magnetic sensor. The media sensor 21 has, at the bottom of the roller 21A, a permanent magnet which becomes displaced in accordance with the rotation of the roller 21A. The magnetic sensor provided in the sensor body 21B detects a change in magnetic force.

The magnetic sensor has its electrical resistance changed in accordance with the magnetic force. The image forming apparatus 1 detects a change in the electrical resistance and thereby detects the thickness of a sheet.

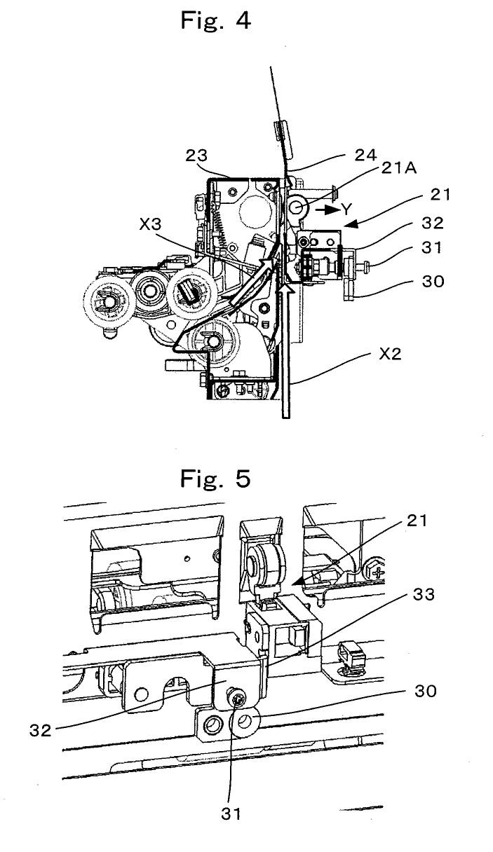

FIG. 4 is a lateral sectional view of the image forming apparatus 1, showing the vicinity of the media sensor perspective view of the image forming apparatus 1, showing the vicinity of the media sensor 21. As shown in FIG. 4 and FIG. 5, the roller 21A of the media sensor 21 is energized by an elastic member so that the roller 21A protrudes into the sheet carrying path from the second sheet guide 24.

The sheet is carried from the direction of an arrow X2 or an arrow X3. The carried sheet displaces the roller 21A in the direction of an arrow Y. When the roller 21A is displaced, the electrical resistance of the magnetic sensor in the sensor body 21B is changed. Therefore, the image forming apparatus 1 detects this change in the electrical resistance and thereby detects the thickness of the sheet.

The media sensor 21 is engaged with a stay 32 of the second sheet guide 24 by a bolt 31 via the vibration isolator 30. The vibration isolator 30 absorbs vibration within the image forming apparatus 1.

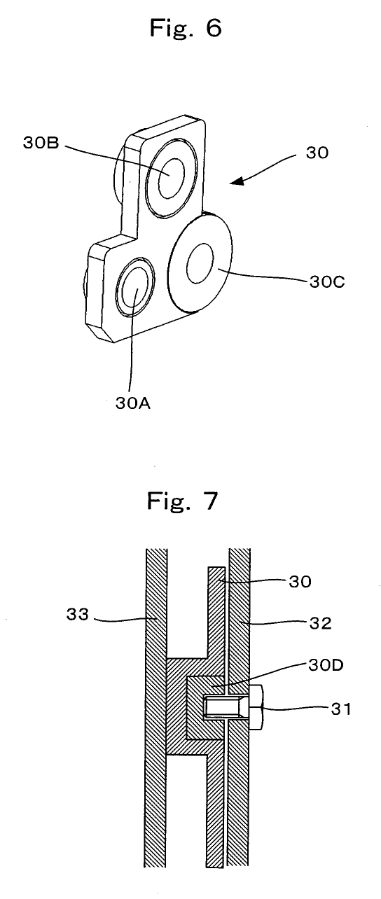

FIG. 6 is a perspective view showing an example of the vibration isolator 30. As shown in FIG. 6, the vibration isolator 30 has a high-frequency vibration absorption damper 30A, a mid-frequency vibration absorption damper 30B, and a low-frequency vibration absorption damper 30C. One of the high-frequency vibration absorption damper 30A, the mid-frequency vibration absorption damper 30B and a low-frequency vibration-absorption damper 30C is selected to support the media sensor 21.

FIG. 7 is a lateral sectional view showing the vicinity of the vibration isolator 30. As shown in FIG. 7, the vibration isolator 30 has a vibration absorber 30D housed in a casing. The bolt 31 is inserted in a bolt insertion hole in the stay 32 of the second sheet guide 24. An axial part of the bolt 31 is abutted against the vibration absorber 30D. The casing of the vibration isolator 30 is abutted against a frame 33 of the media sensor 21.

Therefore, vibration on the side of the stay 32 of the second sheet guide 24 is absorbed by the vibration absorber 30D and is not transmitted to the media sensor 21.

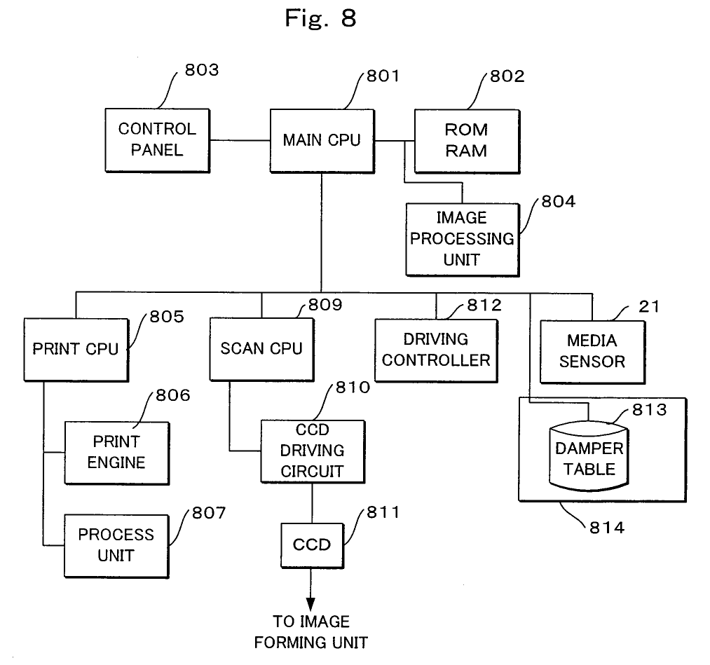

FIG. 8 is a schematic view showing the configuration of the image forming apparatus 1. As shown in FIG. 8, the image forming apparatus 1 has a main CPU 801 as a controller which performs central control of the entire image forming apparatus 1, a control panel 803 as a display device connected to the main CPU 801, a ROM and RAM 802 as a memory device, and an image processing unit 804 which carries out image processing.

The main CPU 801 is connected to a print CPU 805 which controls each unit in an image forming system, a scan CPU 809 which controls each unit in an image scanning system, and a driving controller 812 which controls a driving unit.

The main CPU 801 is also connected to the media sensor 21 and a damper table 813. The damper table 813 stores a frequency band of vibration to be absorbed for each type of vibration isolator. By searching the damper table 813 on the basis of the number of vibrations, the image forming apparatus 1 can determine an optimum vibration isolator.

The image forming apparatus 1 has a memory unit 814 as a memory device such as a non-volatile memory, hard disk drive or RAM. The memory unit 814 houses the damper table 813.

The print CPU 805 controls a print engine 806 which forms an electrostatic latent image on the photoconductive drum, and a process unit 807 which forms a developer image.

The scan CPU 809 controls a CCD driving circuit 810 which drives a CCD 811. A signal from the CCD 811 is outputted to the image forming unit.

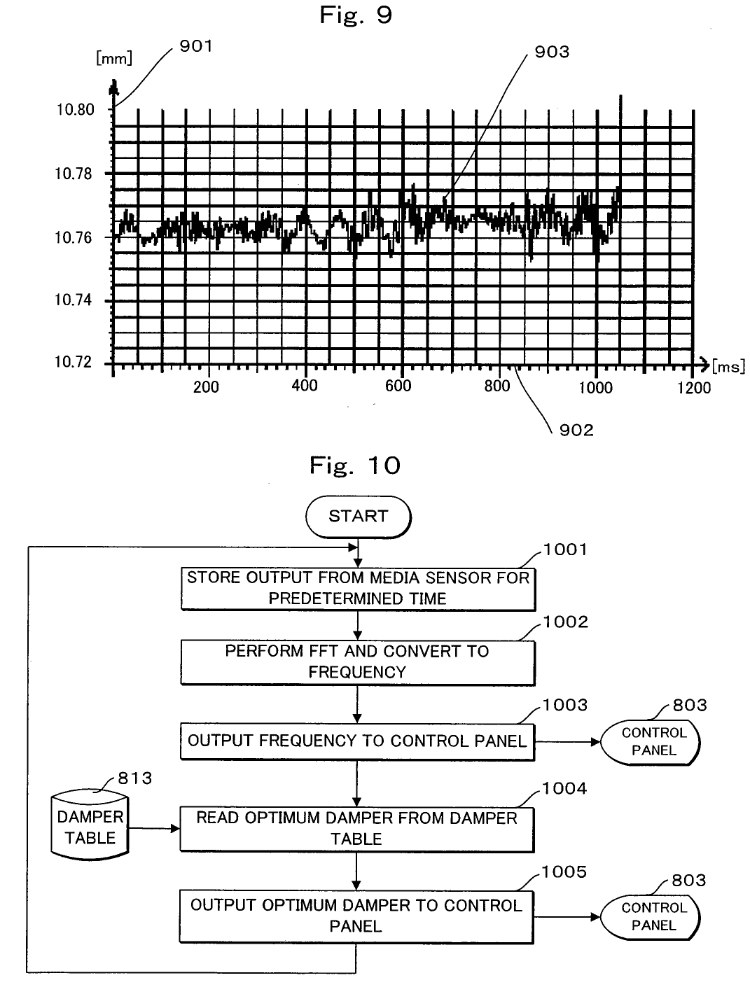

FIG. 9 shows a vibration detected by the image forming apparatus 1 on the basis of an output from the media sensor 21. In FIG. 9, the vertical axis represents the position [mm] of the roller 21A and the horizontal axis represents time [ms]. A graph 903 shows the vibration detected by the image forming apparatus on the basis of the output from the media sensor 21.

As shown in FIG. 9, the vibration within the image forming apparatus 1 can, be detected by the media sensor 21.

FIG. 10 is a flowchart showing the operation of the image forming apparatus 1. As shown in FIG. 10, in ACT 1001, the image forming apparatus 1 samples an output from the media sensor 21 and stores the sampled output in the memory device 802. In ACT 1002, the image forming apparatus 1 performs fast Fourier transform on the stored waveform by using the main CPU 801 and thus converts the waveform to a frequency.

In ACT 1003, the image forming apparatus 1 outputs the converted frequency to the control panel 803. Here, the image forming apparatus 1 may output a frequency category such as “high frequency”, “mid frequency” or “low frequency” in the form of words or symbol instead of the frequency.

In ACT 1004, the image forming apparatus 1 searches the damper table 813 on the basis of the frequency acquired as a result of the conversion and reads an optimum vibration isolator.

For example, if the converted frequency is a high frequency, a vibration isolator for high frequency is read. If the converted frequency is a mid frequency, a vibration isolator for mid frequency is read. If the converted frequency is a low frequency, a vibration isolator for low frequency is read

In ACT 1005, the image forming apparatus 1 outputs the type of the optimum vibration isolator that is read, to the control panel 803.

Here, the operator replaces the vibration isolator. After the replacement, each operation from ACT 1001 to ACT 1005 is repeated again for confirmation. If it is confirmed that vibration is absorbed, the operator designates interruption and suspends the processing.

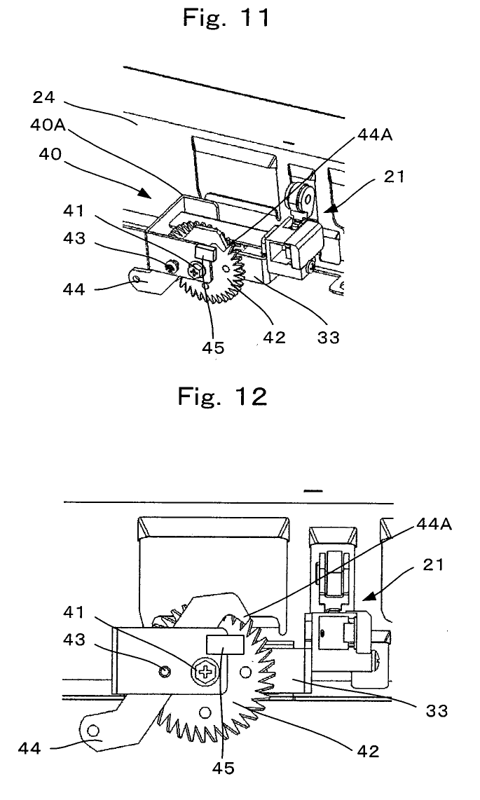

FIG. 11 is a perspective view showing the vicinity of a isolator changer 40. FIG. 12 is a front view showing the vicinity of the isolator changer 40.

As shown in FIG. 11 and FIG. 12, the isolator changer 40 has a supporting frame 40A which is connected to the second sheet guide 24 of the sheet carrying device 17, a hook member 44 as a driver turnably attached to the supporting frame 40A, a gear 42 rotatably attached to the supporting frame 40A, and an encoder 45 as a rotation angle detection device to detect the rotation angle of the gear 42.

The supporting frame 40A may be connected to a site where there is less vibration than in the second sheet guide 24 of the image forming apparatus 1.

The hook member 44 has a pawl 44A at its one end. The other end of the hook member 44 is connected to a driving unit. The pawl 44A is meshes with the teeth of the gear 42. When the hook member 44 is turned by the driving unit, the pawl 44A pushes and rotates the gear 42. The rotation angle is detected by the encoder 45.

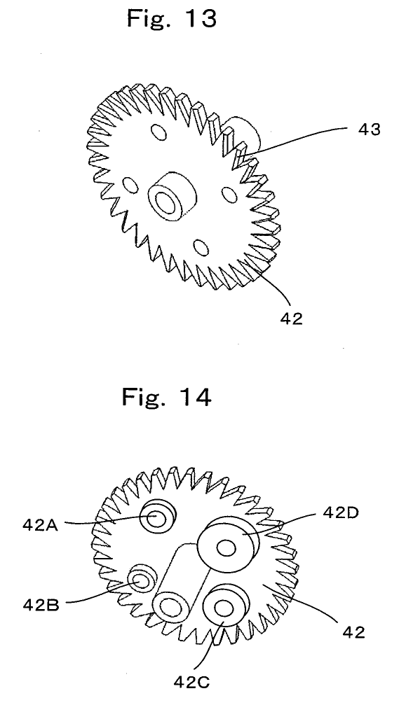

FIG. 13 is a front perspective view of the gear 42. FIG. 14 is a back perspective view of the gear 42. As shown in FIG. 13 and FIG. 14, the gear 42 has teeth having chamfered parts 43, and plural vibration isolators 42A, 42B, 42C and 42D to absorb vibrations of different frequencies. The plural vibration isolators 42A, 42B, 42C and 42D are arranged circumferentially about the center of rotation of the gear 42.

The gear 42 is made of a plastic. The gear 42 is integrally formed with the plural vibration isolators 42A, 42B, 42C and 42D made of a rubber.

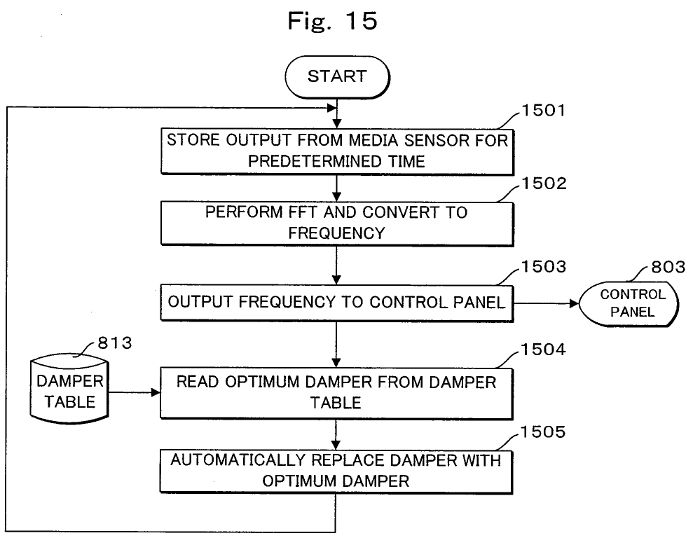

FIG. 15 is a flowchart showing the vibration isolator automatic replacement in the image forming apparatus 1. As shown in FIG. 15, in ACT 1501, the image forming apparatus 1 samples an output from the media sensor 21 and stores the sampled output in the memory device 802. In ACT 1502, the image forming apparatus 1 performs fast Fourier transform on the stored waveform by using the main CPU 801 and thus converts the waveform to a frequency.

In ACT 1503, the image forming apparatus 1 outputs the converted frequency to the control panel 803. The image forming apparatus 1 may output a frequency category such as “high frequency”, “mid frequency” or “low frequency” in the form of words or symbol instead of the frequency.

Here, the operator first removes the bolt 31. Next, as the operator designates automatic replacement of the vibration isolator through the control panel 803, the image forming apparatus 1 starts the automatic replacement of the vibration isolator.

In ACT 1504, the image forming apparatus 1 searches the damper table 813 on the basis of the frequency acquired as a result of the conversion and reads an optimum vibration isolator to absorb the detected frequency.

For example, if the converted frequency is a high frequency, a vibration isolator for high frequency is read. If the converted frequency is a mid frequency, a vibration isolator for mid frequency is read. If the converted frequency is a low frequency, a vibration isolator for low frequency is read.

In ACT 1505, the image forming apparatus 1 causes the driving unit to operate and thus rotates the gear 42. The image forming apparatus 1 detects the rotation angle of the gear 42 on the basis of an output from the encoder 45, and rotates the gear 42 until the vibration isolator to absorb the detected frequency moves to the position of the vibration isolator.

The operator then attaches the bolt 31. After the replacement, each operation from ACT 1501 to ACT 1503 is repeated again for confirmation. If it is confirmed that vibration is absorbed, the operator designates interruption and suspends the processing.

As described above, the image forming apparatus 1 according to this embodiment has the media sensor 21 which is arranged at a halfway part in the sheet carrying path, the damper table 813 storing the frequency band of vibration to be absorbed for each type of vibration isolator, and the controller which samples an output from the media sensor 21, performs Fourier transform on the waveform acquired as a result of the sampling, thus calculates the frequency, then searches the damper table 813 on the basis of the resulting frequency, reads an optimum vibration isolator, and outputs the optimum vibration isolator to the control panel 803.

Thus, there is an advantage that an optimum vibration isolator can be selected quickly and easily without using any special external device.

While certain embodiments have been described, these embodiments have been presented by way of example only, and are not intended to limit the scope of the invention. Indeed, the novel methods and systems described herein may be embodied in a variety, of other forms; furthermore, various omissions, substitutions and changes in the form of the methods and systems described herein may be made without-departing from the spirit of the invention. The accompanying claims and their equivalents are indeed to cover such forms or modifications as would fall within the scope and spirit of the invention.

What is claimed is:

1. An image forming apparatus comprising:
an electrostatic latent image carrier which carries an electrostatic latent image;
a developing device which develops the electrostatic latent image to a developer image;
a sheet carrying device which carries a sheet;
a sensor which outputs a signal corresponding to a thickness of the sheet in order to detect the thickness of the sheet;
a transfer device which transfers the developer image to the sheet;
a fixing device which fixes the developer image to the sheet; and
a controller which outputs a frequency of the signal.

2. The apparatus according to claim 1, further comprising a vibration isolator which isolates the sensor from vibration of the sheet carrying device.

3. The apparatus according to claim 2, further comprising a memory unit which stores a frequency band of vibration to be absorbed for each type of the vibration isolator,
wherein the controller
searches the memory unit on the basis of the frequency,
reads the vibration isolator that is optimum, and
outputs the optimum vibration isolator to a display device.

4. The apparatus according to claim 2, wherein the vibration isolator is a part of a vibration isolator unit having another vibration isolator for a different frequency of vibration to be absorbed.

5. The apparatus according to claim 2, further comprising:
a supporting frame connected to the sheet carrying device;
a gear which rotates against the supporting frame and has plural vibration isolators including the vibration isolator;
a driver which turns the gear against the supporting frame; and
a rotation angle detection device which detects a rotation angle of the gear.

6. The apparatus according to claim 5, wherein the vibration isolator is made of a rubber and the gear is made of a plastic.

7. The apparatus according to claim 5, wherein the driver has a pawl which is meshed with teeth of the gear.

8. The apparatus according to claim 5, wherein the gear has the plural vibration isolators circumferentially about a center of rotation of the gear.

9. The apparatus according to claim 2, wherein the controller samples an output from the sensor again and outputs a frequency of a waveform acquired by the sampling, after a vibration isolator is replaced.

10. The apparatus according to claim 5, wherein the controller samples an output from the sensor again and outputs a frequency of a waveform acquired by the sampling to a display device, after the vibration isolator is replaced.

11. A vibration isolator selection method for an image forming apparatus with a controller comprising:
sampling an output from a sensor which outputs a signal corresponding to a thickness of a sheet in order to detect the thickness of the sheet; and
outputting a frequency of the signal.

12. The method according to claim 11, comprising, outputting a frequency of vibration transmitted to the sensor via a vibration isolator which isolates the sensor from vibration of a sheet carrying device.

13. The method according to claim 12, wherein the controller
searches a memory unit which stores a frequency band of vibration to be absorbed for each type of the vibration isolator, on the basis of the frequency,
reads the vibration isolator that is optimum, and
outputs the optimum vibration isolator to a display device.

14. The method according to claim 12, wherein the vibration isolator is a part of a vibration isolator unit having another vibration isolator for a different frequency of vibration to be absorbed.

15. The method according to claim 12, wherein in accordance with an output from a rotation angle detection device which detects a rotation angle of vibration-isolating damper gear having plural vibration-isolating dampers, the controller rotates the vibration-isolating damper gear.

16. The method according to claim 15, wherein the vibration isolator is made of a rubber and the gear is made of a plastic.

17. The method according to claim 15, wherein a driver has a pawl which is meshed with teeth of the gear.

18. The method according to claim 15, wherein the gear has the plural vibration isolators circumferentially about a center of rotation of the gear.

19. The method according to claim 12, wherein the controller samples an output from the sensor again and outputs a frequency of a waveform acquired by the sampling, after a vibration isolator is replaced.

20. The method according to claim 15, wherein the controller samples an output from the sensor again and outputs a frequency of a waveform acquired by the sampling to a display device, after the vibration isolator is replaced.
